(19) United States
(12) Patent Application Publication
(10) Pub. No.: US 2024/0273477 A1
(43) Pub. Date: Aug. 15, 2024

(54) SYSTEMS THINKING IN ASSET INVESTMENT PLANNING

(71) Applicant: COPPERLEAF TECHNOLOGIES INC., Vancouver (CA)

(72) Inventors: Stanley Thomas COLEMAN, North Vancouver (CA); John KLIPPENSTEIN, New Westminster (CA)

(21) Appl. No.: 18/290,043

(22) PCT Filed: May 17, 2022
(86) PCT No.: PCT/US2022/029644

§ 371 Date: Nov. 9, 2023

Related U.S. Application Data
(60) Provisional application No. 63/189,246, filed on May 17, 2021.

(51) Int. Cl. G06Q 10/20; G06Q 40/06

(52) U.S. Cl. CPC G06Q 10/20; G06Q 40/06

(57) ABSTRACT

A method, apparatus and system for managing asset intervention while considering how the interventions amongst the assets inter-relate include receiving information regarding at least one of asset parameters or network parameters via, for example, a GUI or at least one sensor, implementing heuristics and the at least one of the asset parameters or the network parameters to determine and propose, as at least one asset model, a best set of candidate interventions for a bundle of asset interventions for a defined period of time, and implementing at least one prioritization algorithm to prioritize across the determined at least one asset model to determine a priority for implementing the candidate interventions. The determination of the priority can be limited by constraints. In addition, machine learning processes can be implemented to determine and propose, as at least one asset model, a best set of candidate interventions for a defined period of time.

### FIELD

Embodiments of the present principles generally relate to asset management, and more particularly, to methods, apparatuses, and systems for managing asset intervention while considering how the interventions amongst the assets inter-relate and affect each other.

### BACKGROUND

Utility managers manage many assets and are responsible for scheduling interventions (e.g., operations, maintenance reviews, repairs, etc.) for each of the assets. An intervention performed on one or more assets can affect interventions to be scheduled or performed for other assets.

For example, a railway utility manages millions of assets (e.g., tracks, earthworks, switches, structures, signaling equipment, electrification equipment, etc.). The interventions to be considered on such assets are quite complex. For example, a structure (e.g., bridge) consists of many decks and supports and each of those decks and supports consist of many constituent assets of, for example girders, which can be referred to as minor assets.

For a single bridge many possible interventions can be considered and scheduled, for example, including but not limited to:
Examinations occurring at the bridge level
replacements or strengthening of components occurring at the deck level
minor assets, such as individual girders, being replaced or maintained
maintenance or replacement of minor assets within a deck and possibly neighboring supports being bundled into a larger scale intervention for efficiency.

There exists no current solution which enables a manager, when scheduling interactions, to take into account how interactions performed on a first set of assets affect a desirability for and need to schedule interactions for a second set of assets; for example:
How replacing a girder within a deck can improve the condition of the deck, which decreases a desirability of performing a deck replacement and decreases the frequency at which the parent bridge needs to be examined which in turn impacts when there will exist a need for interventions of all assets within the bridge;
How replacing a deck removes minor assets from a deck and replaces those minor assets with new minor assets affecting a need to schedule interventions for the previous minor assets;
How one minor asset degrading within a deck impacts the degradation of neighboring minor assets in the same deck;
How there are cost and downtime advantages of working on neighboring assets, such that if one minor asset within a deck requires an intervention, simultaneously working on neighboring assets that also require interventions can reduce a total cost associated with the performance of interventions on all minor assets within the same deck.

### SUMMARY

Embodiments of methods, apparatuses and systems for managing asset intervention while considering how the interventions amongst the assets inter-relate and affect each other are disclosed herein.

In some embodiments in accordance with the present principles, a method for managing asset intervention includes receiving information regarding at least one of asset parameters or network parameters by for example enabling a user to define at least one of asset parameters or network parameters via, for example, a GUI, implementing heuristics and the at least one of the asset parameters or the network parameters to determine and propose, as at least one asset model, a best set of candidate interventions for a bundle of asset interventions for a defined period of time, and implementing at least one prioritization algorithm to prioritize across the determined at least one asset model to determine a priority for implementing the candidate interventions. In some embodiments, the determination of the priority can be limited by constraints.

In some embodiments in accordance with the present principles, an apparatus for managing asset intervention includes a processor, and a memory coupled to the processor, the memory having stored therein at least one of programs or instructions executable by the processor. The processor and the programs stored in the memory configure the apparatus to receive information regarding at least one of asset parameters or network parameters by for example enabling a user to define at least one of asset parameters or network parameters enable a user to define at least one of asset parameters or network parameters, implement heuristics and the at least one of the asset parameters or the network parameters to determine and propose, as at least one asset model, a best set of candidate interventions for a bundle of asset interventions for a defined period of time, and implement at least one prioritization algorithm to prioritize across the determined at least one asset model to determine a priority for implementing the candidate interventions. In some embodiments, the prioritizing is subject to constraints.

In some embodiments in accordance with the present principles, a system for managing asset intervention includes a database for storing at least asset attributes and asset relationships, an input device for enabling input to the system, an output device for outputting results of the system, and an apparatus for managing asset intervention, the apparatus including at least a processor, and a memory coupled to the processor, the memory having stored therein at least one of programs or instructions executable by the processor. The processor and the memory are implemented to configure the apparatus to receive information regarding at least one of asset parameters or network parameters by for example enabling a user to define at least one of asset parameters or network parameters enable a user to define at least one of asset parameters or network parameters, implement heuristics and the at least one of the asset parameters or the network parameters to determine and propose, as at least one asset model, a best set of candidate interventions for a bundle of asset interventions for a defined period of time, and implement at least one prioritization algorithm to prioritize across the determined at least one asset model to determine a priority for implementing the candidate interventions. In some embodiments, the prioritizing is subject to constraints.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of an asset intervention management system in accordance with an embodiment of the present principles.

FIG. 2 depicts a high-level block diagram of a computing device in which an embodiment of an asset intervention management system can be implemented in accordance with an embodiment of the present principles.

FIG. 3 depicts a high-level block diagram of a network in which embodiments of an asset intervention management system in accordance with the present principles can be applied.

FIG. 4 depicts a flow diagram of a method for managing asset intervention in accordance with an embodiment of the present principles.

FIG. 5 depicts a high-level block diagram of a bridge containing, for example 3 supports, 2 decks and with each deck and support composed of multiple minor assets (e.g., girders) on which embodiments of the present principles can be applied including sensors of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatus and systems for managing asset intervention while considering how the interventions amongst the assets inter-relate and affect each other. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to a particular asset manager of specific asset types, such teachings should not be considered limiting. Embodiments in accordance with the present principles can be implemented by other types of managers and applied to substantially any type of assets within the concepts of the present principles.

Embodiments in accordance with the present principles provide methods, apparatuses and systems to create a best plan for all interventions across an entire network of assets, while taking into account cost and resource constraints.

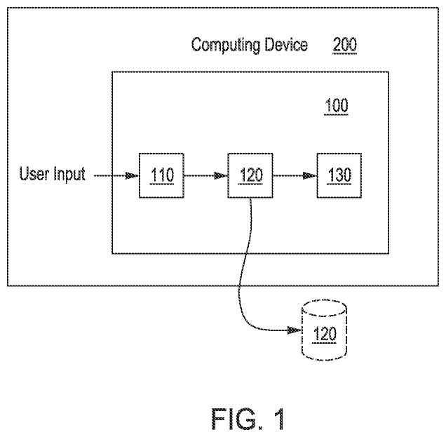

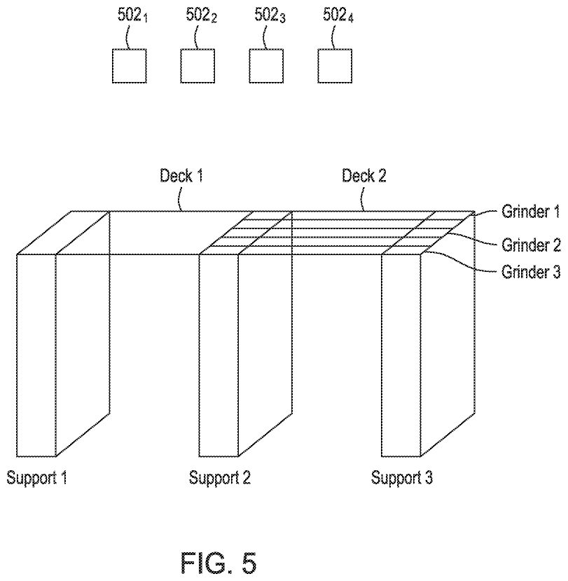

FIG. 1 depicts a high-level block diagram of an asset intervention management system 100 in accordance with an embodiment of the present principles. The asset intervention management system 100 of FIG. 1 illustratively comprises a control input module 110, a modeling module 120, and a prioritizing module 130. Embodiments of the present principles can also interact with various optional sensors (depicted in and described in more detail with reference to FIG. 5), which can provide inputs to the asset intervention management system 100.

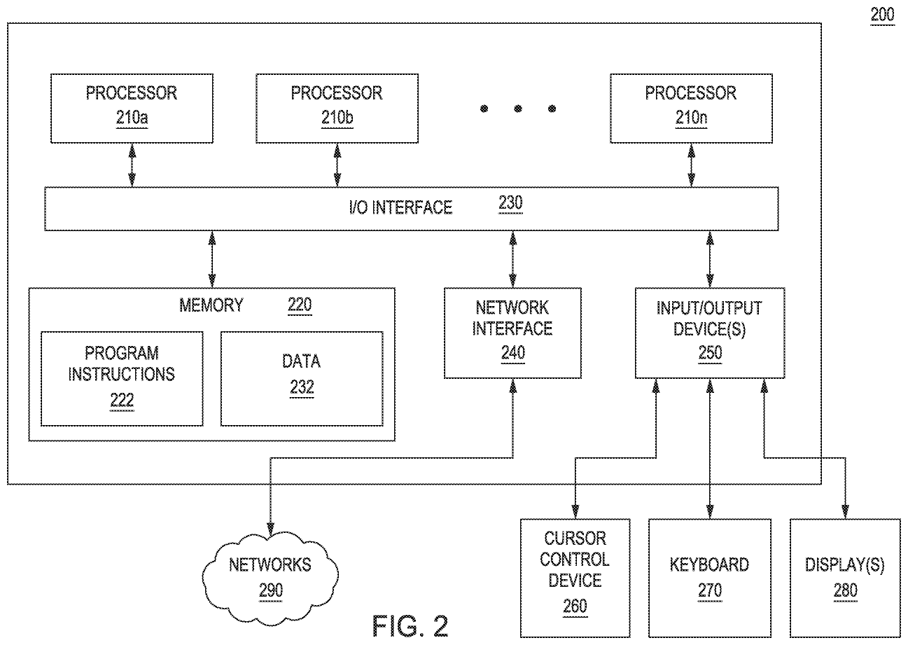

As depicted in FIG. 1, embodiments of an asset intervention management system can be implemented in a computing device 200 (e.g., desktop computer, PC, mobile phone, laptop, server, cloud-based server, or other suitable computing device, described in greater detail in FIG. 2) in accordance with the present principles. That is, in some embodiments data including but not limited to asset attributes and asset relationships can be received by components of the asset intervention management system 100 from the computing device 200 using any input/output means associated with the computing device 200. Results of an asset intervention management system in accordance with the present principles can be presented to a user using an output device of the computing device 200, such as a display, a printer or any other form of output device. In some embodiments, inputs and outputs to and from an asset intervention management system in accordance with the present principles, such as the asset intervention management system 100 of FIG. 1, can be achieved using a graphical user interface (not shown) provided by for example the computing device 200.

In some embodiments, information and data regarding asset attributes and asset relationships can be stored in a database. In some embodiments, the database can include an optional database 140 of the asset intervention management system 100 of FIG. 1. Alternatively or in addition, the database for storing at least asset attributes and asset relationships can be a database associated with the computing device 200 (described in greater detail below). In some embodiments, the database of the present principles can include some or all of the attributes of each of the individual assets and the relationship between assets (e.g., which assets interact with one another (bundle)). For example, in one embodiment including bridges, the bundle can be defined as the bridge, as all components interact. However, in an embodiment including railway tracks, the bundle can be defined as each section of track between switches. Asset attributes can include at least information regarding a condition/status of an asset, for example, information obtained from inspections and tests, properties of the asset for example material, age, manufacturer and other physical attributes. Asset attributes can further include information such as usage data, for example, in-service date, number of operations, and the like.

Referring back to the asset intervention management system 100 of FIG. 1, the control input module 110 enables a user to define asset parameters and network parameters for asset management. Such parameters can include but are not limited to, number of assets, number of minor assets, a time period of interest (e.g., years) and network constraints, including limits on any combination of intervention volume, intervention costs, time constraints and the like on any subset of the assets being managed. For example, in some embodiments, the time period of interest defines the period over which interventions are to be considered and the intervention costs represent a constraint on the total amount of dollars that are to be spent in a specific time period. For example, if the time period of interest is from 2022 until 2055, then intervention costs could be specified, such as do not exceed $1M in January 2022, and $1.5M in February 2022, etc. Similarly on any time period a constraint could be placed on the volume of work that could be performed, for example, do not exceed replacing 100 square meters of deck in January 2022 and 112 square meters in February 2022.

In some embodiments of the present principles, at least some information regarding asset parameters can be determined using sensors. For example, as depicted in FIG. 5, the asset intervention management system 100 of FIG. 1 can receive information from sensors 5021-5024, which in some embodiments include at least one camera capable of capturing images of assets and minor assets comprising an asset. In such embodiments, the control input module 110 of the asset intervention management system 100 of FIG. 1 can be configured to determine, from images received from at least one of the sensors 5021-5024, asset information including but not limited to a number of assets, asset types, a relationship between assets and/or minor assets, and the like. For example and with reference to FIG. 5, at least one of the sensors 5021-5024, can capture images of the bridge of FIG. 5 so that the assets of the bridge including identifying the two decks Deck 1 and Deck 2, the three girders Girder 1, Girder 2, Girder 3, and the three supports, Support 1, Support 2 and Support 3 can be identified. In addition, although in FIG. 5 the sensors 5021-5024 are depicted as not making contact with the bridge and/or the assets, in some embodiments of the present principles, sensors can make contact with assets and minor assets to capture data. For example, in some embodiments of the present principles, the sensors 5021-5024 can include vibrational sensors for capturing vibrational data from assets, temperature sensors for capturing temperature information from assets, and any other sensor that can capture asset parameters.

In the asset intervention management system 100 of FIG. 1, the modelling module 120 has access to all available information/data regarding asset attributes including constraints, asset relationships, asset parameters, network parameters and the like from, for example, at least one of the control input module 110 and/or a database of the present principles, such as the optional database 140 of FIG. 1, a database associated with the computing device 200, a database associated with cloud storage, or any other database accessible by the modelling module 120. The modeling module 120 uses the available information/data to determine at least one model of a state/condition of at least each of the assets, and in some embodiments, sub-portions of the assets, for determining for which assets/sub-portions of assets intervention can be required. For example, in some embodiments, the modeling module 120 can apply calculations/algorithms, heuristics and bundling logic specific to each new asset type (e.g., bridge or track) for determining at least one model of at least a state/condition of an asset(s) and/or sub-portion of an asset. More specifically, in some embodiments the modelling module 120 uses heuristics and other calculations/algorithms to propose, as Asset Models, a best set of candidate interventions for assets, asset portions, and/or an entire bundle for a designated time period and communicates the candidate interventions to the prioritizing module 130. In addition, in some embodiments of the present principles, if a track model defines that an intervention is required on one section of track, cost efficiencies of doing work on neighboring sections of track are investigated to determine if there would exist an overall savings by performing interventions on neighboring sections as part of a same bundle of work.

In some embodiments, stored historical inspection data can be used by the modelling module 120 to establish a degradation model for an asset. In one example, for a bridge containing, for example 3 supports, 2 decks and with each deck and support composed of multiple minor assets (e.g. girders—such as depicted in FIG. 5), the following is an example of an algorithmic procedure that can be implemented by the modeling module 120 to determine a degradation model for assets. For a time period being considered, the state of each of the minor assets in the decks and supports from the state at the start of the period to the anticipated state at the end of the period is degraded as follows. For an example calculation, one of the decks is considered. For this calculation, the period of interest is the year 2024 and the bridge in question was last examined in 2022. The deck of interest for this calculation contains 3 girders.

As of the last examination (2022) each girder was inspected and assigned a condition score from 0 to 100, where 0 represents “as-new” and 100 represents “end-of-life”, as follows:
Girder 1: had a condition score of 85
Girder 2: had a condition score of 70
Girder 3: had a condition of 95.

Based on an analysis of the historical inspection data, a condition degradation curve can be established that predicts the condition degradation per year. For purposes of this example calculation, it is being assumed that the condition degrades one value per year. As such, the anticipated condition of the minor assets in 2024 can be computed as:
Girder 1: had a condition of 87
Girder 2: had a condition of 72
Girder 3: had a condition of 97.

The aggregate condition of the deck can be determined by an aggregation of the condition of the underlying minor assets. In some embodiments, the aggregation can include at least a weighted average, where each minor asset can be weighted based on its significance to the overall structural integrity of the deck. For the purposes of this example calculation, it is being assumed that all the minor assets have an equal weighting and the overall average anticipated condition of the deck (i.e., degradation model) in 2024 can be determined as follows: (87+72+97)/3=85.3.

In another example, the modeling module 120 can determine a failure model for assets. Following the above-described example, a likelihood of a failure of the deck that can lead to an incident can be determined for each deck based on, for example, the above-described condition of the deck. In some embodiments, based on historical analysis of failure data, a probability of failure curve can be established that predicts the likelihood of failure based upon the condition of the deck. For this example calculation it is being assumed that a deck with an aggregate condition of 85.3 has a 1 in 100 chance of causing a failure that would lead to an incident (i.e., derailment) in 2024. For each Deck, based on the traffic on the bridge and the location of the bridge, a consequence of the incident in terms of delay risk to trains and safety risk can be determined as part of the failure model or as a separate model. Both risks can be monetized and the total consequence of the incident is obtained by adding the delay risk and safety risks. In some embodiments, based on anticipated traffic on the bridge in 2024, and historical analysis of derailment data, the expected consequence of a derailment on that bridge can be estimated. That estimate includes both a safety component (fatalities and injuries) and an operational cost. Each of these consequences can be monetized. For this example calculation, it is being assumed that the monetized costs of those components are as follows:
Delay Risk to trains: $100M
Safety Risk: $30M.

As such, the total anticipated consequence of a derailment in this example is $130M. For each Deck a total anticipated monetized risk can be determined by multiplying the likelihood of the failure by the total consequence of the incident. In the example, the total monetized risk is the consequence of $130M multiplied by the probability of failure of 0.01 (1 in 100)=$1.3M. The determined models can be communicated to the prioritizing module 130.

In some embodiments of the present principles, an asset intervention management system of the present principles, such as the asset intervention management system 100 of FIG. 1, can include at least one machine learning process. For example, in some embodiments of the present principles the model module 120 can include a machine learning (ML) process (not shown) to determine an Asset model in accordance with the present principles. In some embodiments, the ML process can include a multi-layer neural network comprising nodes that are trained to have specific weights and biases. In some embodiments, the ML process of, for example, the model module 120 employs artificial intelligence techniques or machine learning techniques to analyze content/data from sensors, such as sensors 5021-5024 of FIG. 5, to determine Asset Models of the present principles. In some embodiments, in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML process can be trained using millions of instances of sensor data to determine an Asset Model in accordance with the present principles. The training teaches the ML process to identify information to be used to generate an Asset Model. For example, many instances of image data from a camera sensor can be used to train an ML process of the present principles how an asset looks at a specific level of degradation or how an asset looks at a point of failure or at a certain amount of time before failure. Over time, the ML process learns to look for specific attributes in the content to determine Asset Models depictive of a condition/status of assets in accordance with the present principles.

The prioritizing module 130 can used the information/data from the model module 120 to determine a priority for managing assets. For example and referring to the example described above, for each Deck, a benefit-to-cost-ratio of replacement can be determined by dividing the monetized risk by the cost of the replacement. Specifically, in the example, the cost of replacing the deck is $1M and the benefit-to-cost ratio is computed as $1.3M/$1M=1.3.

In some embodiments, for each deck with a benefit-to-cost-ratio >1, the prioritizing module 130 can make a suggestion to replace the deck by adding the deck to a list of Candidate Interventions to be considered with a priority equal to the benefit-to-cost ratio. In this example, since the benefit-to-cost ratio is >1, the deck replacement is proposed as a Candidate Intervention in 2024 and given a priority of 1.3.

Generally, in the asset intervention management system 100 of FIG. 1, the prioritizing module implements a prioritization algorithm that can be used to prioritize across one or more Asset Models determined by the model module 120, in some embodiments, using parameters specified by the control input module 110 (i.e., constraints). That is, in some embodiments of the present principles, the prioritizing module 130 receives candidate interventions for each of the bundles from the modelling module 120 and can select the intervention(s) that provide a highest cost efficiency/value while remaining within predefined constraints.

In some embodiments, the prioritizing module 130 implements an algorithm that calculates for a created plurality of bundling strategies created by the modeling module 120 a simplified outage duration and/or outage cost associated with the interventions to be performed for each asset of the plurality of assets. More particularly, the algorithms (equations) can be configured for calculating a simplified estimate of the outage duration and/or outage cost calculations for each asset.

For example, for a bridge containing, for example 3 supports, 2 decks and with each deck and support composed of multiple minor assets (e.g. girders) such as depicted in FIG. 5, the following is an example of an algorithmic procedure that can be implemented by the prioritizing module 130 to determine a most efficient intervention schedule:
For the time period being considered degrade the state of each of the minor assets in the decks and supports from the state at the start of the period to the anticipated state at the end of the period;
For each deck, determine the condition of the deck by aggregating the condition of the minor assets in the deck;
For each Deck based on the condition of the deck, determine the likelihood of a failure of the deck that would lead to an incident;
For each Deck based on the traffic on the bridge and the location of the bridge, determine the consequence of the incident in terms of delay risk to trains and safety risk. Both risks are monetized and the total consequence of the incident is obtained by adding the delay risk and safety risks;
For each Deck determine the total anticipated monetized risk by multiplying the likelihood of the failure by the total consequence of the incident;
For each Deck, compute the benefit-to-cost-ratio of replacement by dividing the monetized risk by the cost of the replacement;
For each Deck replacement with a benefit-to-cost-ratio >1 add the deck replacement to the Candidate Interventions to be considered with a priority equal to the benefit-to-cost ratio.

In some embodiments, for every Deck with a benefit-to-cost-ratio <1, the prioritizing module 130 performs the following:
For every minor asset in the deck, consider each possible intervention (e.g. replace, strengthen, maintain) in priority order. Compute the benefit-to-cost-ratio for each intervention using the same methodology that was used for a deck. For each minor asset select the highest priority intervention with a benefit-to-cost ratio >1 and add that to the list of Candidate Interventions;
If one or more interventions are found with a benefit-to-cost-ratio >1 then determine the benefit-to-cost-ratio of performing that same intervention on all minor assets on the deck. If the benefit-to-cost-ratio of performing the intervention on all minor assets on the deck is greater then the benefit-to-cost ratio of performing only the ones found in the previous step then replace the individual Candidate Interventions with an intervention of the same type on all the minor assets on the deck;
If the above process results in work being performed on any of the decks on the bridge then examine the minor assets that compose each support for that bridge;
For every minor asset in the support, consider each possible intervention (e.g. replace, strengthen, maintain) in priority order.

Compute the benefit-to-cost-ratio for each intervention. For each minor asset select the highest priority intervention with a benefit-to-cost ratio >1 and add that to the list of Candidate Interventions.

In some embodiments of the present principles, the prioritizing module 130 is unable to break apart the candidate bundled interventions that have been determined by the heuristics within the model module 120. In some embodiments, the prioritizing module 130 can communicate the selected interventions back to the model module 120 and the process can be repeated for a next time period using the information regarding the selected interventions for previous time periods.

As described above, in deciding repairs or for which assets to suggest repair/action, a prioritizing module 130 can take into account a constraint(s) imposed on repairs. For example, the following example calculation of Table 1 depicts how a prioritizing module 130 can take into account a constraint(s) imposed on repairs of assets. In the example calculation of Table 1, five bridges (each with 1 or more decks) including five respective Candidate Interventions are evaluated by the prioritizing module 130.

For purposes of the example calculation of Table 1, it is being assumed that there is a constraint of $7M to be spent in 2024. In the example of Table 1, the prioritizing module 130 would select the first three (3) interventions from Table 1, as they are the highest priority interventions and they stay within the constrained budget of $7M.

TABLE 1

| Bridge | Deck | Intervention | Priority | Cost |
|---|---|---|---|---|
| A | 1 | Replacement | 1.3 | $1M |
| B | 1 | Replacement | 3.7 | $2M |
| C | 2 | Replacement | 1.8 | $4M |
| D | 1 | Replacement | 1.1 | $6M |
| E | 3 | Replacement | 1.2 | $3M |

In accordance with some embodiments of the present principles, the prioritizing module 130 is unable to break apart the candidate bundled interventions that have been determined by the heuristics within the model module 120. In some embodiments, the prioritizing module 130 can communicate the selected interventions back to the model module 120 and the process can be repeated for a next time period using the information regarding the selected interventions for previous time periods.

As described above, the output of the prioritizing module 130 can include a report summarizing at least one of all of the interventions that were selected and not selected and the reason for the selection of the asset intervention(s). In some embodiments, the requested outputs in the scenario for a specific time period and assets can be reported/presented as tables and graphs. A user can review the reports and the outputs and, based on the results, can choose to perform another run and modify any of at least one of the asset parameters, network parameters, and/or the constraints. Alternatively or in addition, a user can choose to schedule repairs or interventions for assets based on the output results of an asset intervention management system of the present principles, such as the asset intervention management system 100 of FIG. 1.

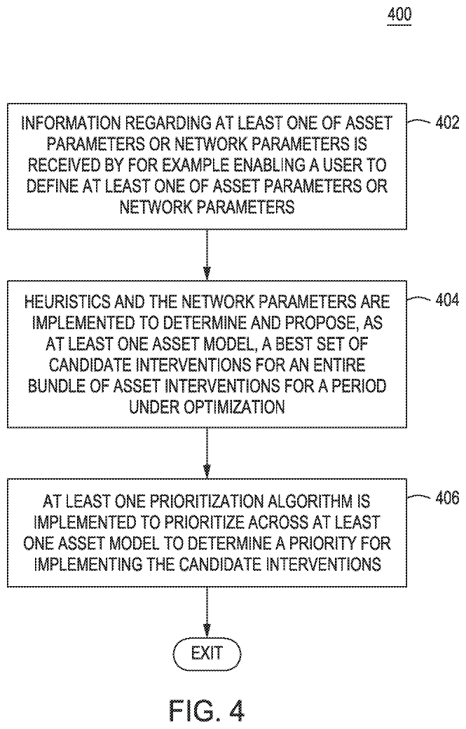

As recited above, in some embodiments an asset intervention management system of the present principles can be implemented in a computing device. FIG. 2 depicts a high-level block diagram of a computing device 200 suitable for implementing embodiments of an asset intervention management system, such as the asset intervention management system 100 of FIG. 1, in accordance with embodiments of the present principles. In some embodiments computing device 200 can be configured to implement methods of the present principles, such as the method 400 of FIG. 4, as processor-executable program instructions 222 (e.g., program instructions executable by processor(s) 210) in some embodiments.

In the embodiment of FIG. 2, the computing device 200 includes one or more processors 210a-210n coupled to a system memory 220 via an input/output (I/O) interface 230. Computing device 200 further includes a network interface 240 coupled to I/O interface 230, and one or more input/output devices 1050, such as cursor control device 260, keyboard 270, and display(s) 280. In various embodiments, any of the components can be utilized by the system to receive user input described above. In various embodiments, a user interface can be generated and displayed on display 280. In some cases, it is contemplated that embodiments can be implemented using a single instance of computing device 200, while in other embodiments multiple such systems, or multiple nodes making up computing device 200, can be configured to host different portions or instances of various embodiments. For example, in one embodiment some elements can be implemented via one or more nodes of computing device 200 that are distinct from those nodes implementing other elements. In another example, multiple nodes may implement computing device 200 in a distributed manner.

In different embodiments, computing device 200 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computing device 200 can be a uniprocessor system including one processor 210, or a multiprocessor system including several processors 210 (e.g., two, four, eight, or another suitable number). Processors 210 can be any suitable processor capable of executing instructions. For example, in various embodiments processors 210 may be general-purpose or embedded processors implementing any of a variety of instruction set architectures (ISAs). In multiprocessor systems, each of processors 210 may commonly, but not necessarily, implement the same ISA.

System memory 220 may be configured to store program instructions 222 and/or data 232, such as asset attributes and asset relationships, accessible by processor 210. In various embodiments, system memory 220 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 220. In other embodiments, program instructions and/or data can be received, sent or stored upon different types of computer-accessible media or on similar media separate from system memory 220 or computing device 200.

In one embodiment, I/O interface 230 can be configured to coordinate I/O traffic between processor 210, system memory 220, and any peripheral devices in the device, including network interface 240 or other peripheral interfaces, such as input/output devices 250. In some embodiments, I/O interface 230 can perform any necessary protocol, timing or other data transformations to convert data signals from one component (e.g., system memory 220) into a format suitable for use by another component (e.g., processor 210). In some embodiments, I/O interface 230 can include support for devices attached through various types of peripheral buses, such as a variant of the Peripheral Component Interconnect (PCI) bus standard or the Universal Serial Bus (USB) standard, for example. In some embodiments, the function of I/O interface 230 can be split into two or more separate components, such as a north bridge and a south bridge, for example. Also, in some embodiments some or all of the functionality of I/O interface 230, such as an interface to system memory 220, can be incorporated directly into processor 210.

Network interface 240 can be configured to allow data to be exchanged between computing device 200 and other devices attached to a network (e.g., network 290), such as one or more external systems or between nodes of computing device 200. In various embodiments, network 290 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 240 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 250 can, in some embodiments, include one or more display terminals, keyboards, keypads, touchpads, scanning devices, voice or optical recognition devices, or any other devices suitable for entering or accessing data by one or more computer systems. Multiple input/output devices 250 can be present in computer system or can be distributed on various nodes of computing device 200. In some embodiments, similar input/output devices can be separate from computing device 200 and can interact with one or more nodes of computing device 200 through a wired or wireless connection, such as over network interface 240.

In some embodiments, users can implement the input/output devices 250 of the computing device 200 to implement the described embodiments of the present principles. For example, a user can implement the input/output devices 250 to upload an Asset Model determined by, for example, the model module 120. In addition, the user can implement the input/output devices 250 to upload attributes of assets (e.g., number, material and length of girders in each deck), network parameters (e.g., assets to include, regions of assets, or all assets in the asset class, time periods to consider, outputs to be generated, for example cost by specific intervention type, condition of assets after interventions, number of each intervention type, and constraints, such as a total budget available for specified time periods), and the like for use by an asset intervention management system of the present principles, such as the asset intervention management system 100 of FIG. 1.

The asset intervention management system of the present principles can generate any asset models and prioritize the Candidate Interventions as described above. From the determined information, an asset intervention management system of the present principles can generate a report summarizing at least one of all of the interventions that were selected and not selected and the reason for the selection of the asset intervention(s). In some embodiments, the requested outputs in the scenario for the requested time period and assets can be reported/presented as tables and graphs. A user can review the reports and the requested outputs and, based on the results, can choose to perform another run and modify any of at least one of the asset parameters, network parameters, and/or the constraints. Alternatively or in addition, a user can choose to schedule repairs or interventions for assets based on the output results of an asset intervention management system of the present principles, such as the asset intervention management system 100 of FIG. 1.

Those skilled in the art will appreciate that computing device 200 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. Computing device 200 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from computing device 200 can be transmitted to computing device 200 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

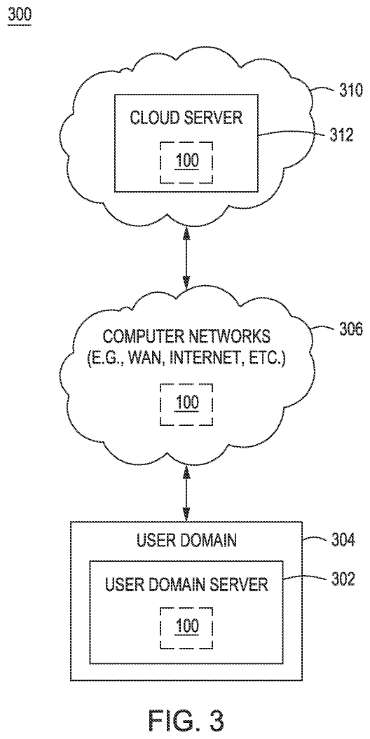

FIG. 3 depicts a high-level block diagram of a network 300 in which embodiments of an asset intervention management system in accordance with the present principles can be applied. The network environment 300 of FIG. 300 illustratively comprises a user domain 302 including a user domain server 304. The network environment 300 of FIG. 3 further comprises computer networks 306, and a cloud environment 310 including a cloud server 312.

In the network environment 300 of FIG. 3, an asset intervention management system in accordance with the present principles, such as the asset intervention management system 100 of FIG. 1 can be implemented in at least one of the user domain server 304, the computer networks 306 and the cloud server 312. That is, in some embodiments, a user can use a local server (e.g., the user domain server 304) to provide network parameters, asset attributes, asset relationships and the like that can be used for managing asset intervention while considering how the interventions amongst the assets inter-relate and affect each other in accordance with the present principles and as described above.

In some embodiments, a user can implement a computing device of an asset intervention management system in the computer networks 306 to provide network parameters, asset attributes, asset relationships and the like and the like that can be used for managing asset intervention while considering how the interventions amongst the assets inter-relate and affect each other in accordance with the present principles and as described above. Alternatively or in addition, in some embodiments, a user can implement a computing device of an asset intervention management system in the cloud server 312 of the cloud environment 310 to provide network parameters, asset attributes, asset relationships and the like that can be used for managing asset intervention in accordance with the present principles and as described above. For example, in some embodiments it can be advantageous to perform processing functions of the present principles in the cloud environment 310 to take advantage of the processing capabilities of the cloud environment 310. In some embodiments in accordance with the present principles, an asset intervention management system can be located in a single or multiple locations/servers/computers to perform all or portions of the herein described functionalities of an asset intervention management system in accordance with the present principles.

FIG. 4 depicts a flow diagram of a method for managing asset intervention in accordance with an embodiment of the present principles. The method 400 can begin at 402 during which information regarding at least one of asset parameters or network parameters is received via, for example, a GUI or at least one sensor. For example and as described above, a GUI can be provided for enabling a user to input network parameters, including but not limited to, a time period of interest (e.g., years) and network constraints, including limits on any combination of intervention volume, intervention costs, time constraints and the like for any subset of assets being prioritized. Alternatively or in addition, sensors can be used to input such information. The method 400 can proceed to 404.

At 404, heuristics and the network parameters are implemented to determine and propose, as at least one Asset Model, a best set of candidate interventions for an entire bundle of asset interventions for a period under optimization. Alternatively or in addition, a machine learning process can be implemented to propose, as at least one Asset Model, a best set of candidate interventions for an entire bundle of asset interventions for a period under optimization using inputs from at least one sensor. The method 400 can proceed to 406.

At 406, at least one prioritization algorithm is implemented to prioritize across the at least one Asset Model. The method 400 can be exited.

Embodiments of Asset Intervention Management in accordance with the present principles can be implemented in a support tool enabling an asset owner/manager to determine and understand a most efficient way to manage assets within a budget.

Embodiments of Asset Intervention Management in accordance with the present principles can further be implemented in a performance management support tool to understand if an execution plan will consume all the expected budget in a current planned time period and to better predict short-term and long-term cash flows.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

What is claimed:

1. A method for managing asset intervention, comprising:
receiving information regarding at least one of asset parameters or network parameters;
implementing heuristics and the at least one of the asset parameters or the network parameters to determine and propose, as at least one asset model, a best set of candidate interventions for a defined period of time; and
implementing at least one prioritization algorithm to prioritize across the determined at least one asset model to determine a priority for implementing the candidate interventions.

2. The method of claim 1, wherein the at least one of asset parameters or network parameters are received via at least one of a graphical user interface (GUI) or at least one sensor.

3. The method of claim 1, wherein asset attributes and asset relationships for assisting in determining the at least one asset model are retrieved from at least one of database or at least one sensor.

4. The method of claim 1, wherein the network parameters comprise at least one of a time period of interest and network constraints, including limits on any combination of intervention volume and intervention costs.

5. The method of claim 1, wherein the at least one prioritization algorithm is limited by at least one constraint.

6. The method of claim 1, wherein at least one of interventions or repairs for assets are performed or scheduled based on the determined priority.

7. The method of claim 6, further comprising outputting a report including at least the determined priority for the candidate interventions.

8. The method of claim 1, further comprising implementing a machine learning process to determine and propose, as at least one asset model, a best set of candidate interventions for a defined period of time.

9. An apparatus for managing asset intervention, comprising:
a processor; and
a memory coupled to the processor, the memory having stored therein at least one of programs or instructions executable by the processor to configure the apparatus to:
receive information regarding at least one of asset parameters or network parameters;
implement heuristics and the at least one of the asset parameters or the network parameters to determine and propose, as at least one asset model, a best set of candidate interventions for a defined period of time; and
implement at least one prioritization algorithm to prioritize across the determined at least one asset model to determine a priority for implementing the candidate interventions.

10. The apparatus of claim 9, further comprising a graphical user interface (GUI) and wherein the information regarding at least one of asset parameters or network parameters is received via at least one of the GUI or at least one sensor.

11. The apparatus of claim 9, further comprising a database and wherein asset attributes and asset relationships for assisting in determining the at least one asset model are retrieved from at least one of the database or at least one sensor.

12. The apparatus of claim 9, wherein the network parameters comprise at least one of a time period of interest and network constraints, including limits on any combination of intervention volume and intervention costs.

13. The apparatus of claim 9, wherein the at least one prioritization algorithm is limited by at least one constraint.

14. The apparatus of claim 9, wherein at least one of interventions or repairs for assets are performed or scheduled based on the determined priority.

15. The apparatus of claim 14, further comprising an output device wherein the output device outputs a report including at least the determined priority for the candidate interventions.

16. A system for managing asset intervention, comprising:
a database for storing at least asset attributes and asset relationships;
an input device for enabling input to the system.
an output device for outputting results of the system; and
an apparatus for managing asset intervention, comprising:
a processor; and
a memory coupled to the processor, the memory having stored therein at least one of programs or instructions executable by the processor to configure the apparatus to:
receive information regarding at least one of asset parameters or network parameters;
implement heuristics and the at least one of the asset parameters or the network parameters to determine and propose, as at least one asset model, a best set of candidate interventions for a defined period of time; and
implement at least one prioritization algorithm to prioritize across the determined at least one asset model to determine a priority for implementing the candidate interventions.

17. The system of claim 16, wherein the input device comprises at least one of a sensor or a graphical user interface (GUI) and wherein the information regarding at least one of asset parameters or network parameters is received via at least one of the GUI or the sensor.

18. The system of claim 16, wherein asset attributes and asset relationships for assisting in determining the at least one asset model are retrieved from at least one of the database or the sensor.

19. The system of claim 16, wherein the network parameters comprise at least one of a time period of interest and network constraints, including limits on any combination of intervention volume and intervention costs.

20. The system of claim 16, wherein the at least one prioritization algorithm is limited by at least one constraint.

21. The system of claim 16, wherein at least one of interventions or repairs for assets are performed or scheduled based on the determined priority and a report including at least the determined priority for the candidate interventions is output from the output device.
